(19) United States
(12) Patent Application Publication
(10) Pub. No.: US 2004/0207744 A1
(43) Pub. Date: Oct. 21, 2004

(54) Scanning camera

(76) Inventor: Gerhard Bock, Gauting (DE)

Correspondence Address: BELL, BOYD & LLOYD, LLC, P. O. BOX 1135, CHICAGO, IL, 60690-1135, US

(21) Appl. No.: 10/487,859

(22) PCT Filed: Jul. 23, 2002
(86) PCT No.: PCT/DE02/02703

(30) Foreign Application Priority Data
Aug. 28, 2001 (DE) 101 41 908.2

(51) Int. Cl. H04N 5/225

(52) U.S. Cl. 348/335

(57) ABSTRACT

The invention relates to a scanning camera (SC) comprising a two-dimensionally displaceable micro-mirror (SP) for scanning an object (OB) and for representing said image on an anastigmatic optoelectric sensor (SE), which is configured for converting an image that is scanned by time-division multiplexing into electric image data. According to the invention, the micro-mirror (SP) and the optoelectric sensor (SE) are arranged on one plane and a deflection mirror (US) is located in the optical path between the micro-mirror (SP) and the optoelectric sensor (SE).

The invention relates to a so-called scanning camera.

The optoelectric image sensors currently used in cameras or digital cameras, camcorders and video telephones are based on semiconductor chips with an array of light-sensitive elements known as pixels. To map an object onto this sensor there is provided a lens system which in the simplest case consists of a single lens. A system of this kind is prone to distortions, requires focusing or has a fixed focus range, and is limited in its resolution.

The manufacturers of the abovementioned devices are endeavoring to reduce the weight, size and cost. The lens focal length and the distance of the lens from the image sensor is governed by the sensor diagonal and the camera angle. Any further miniaturization by reducing the sensor diagonal and therefore the pixel size requires much higher-quality and therefore more expensive optics.

The object of the invention is therefore to specify a smaller yet inexpensive camera.

This object is achieved by the features detailed in the claims.

In the camera according to the invention a lens is no longer required and all the optical characteristics can be significantly improved.

The size of the scanning camera according to the invention is drastically reduced compared to the conventional cameras with lens system and sensor array.

The invention will now be described with reference to the embodiments illustrated in the accompanying drawings, in which:

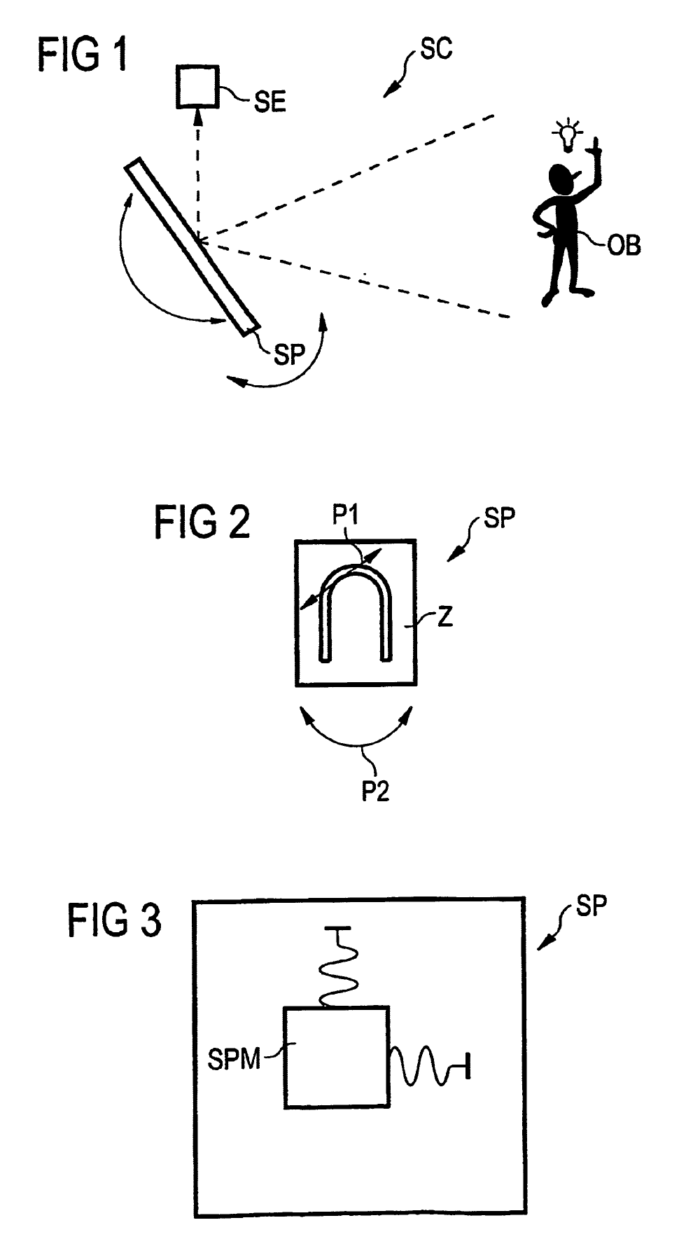

FIG. 1 shows a general view of the scanning camera according to the invention,

FIGS. 2 and 3 show embodiments for an associated micro-mirror, and

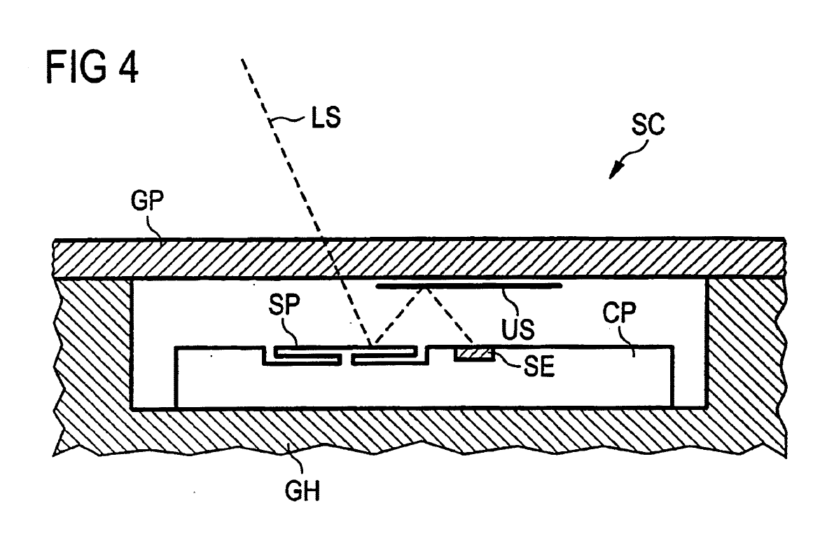

FIG. 4 shows an implementation of the scanning camera according to the invention on a chip.

The scanning camera (SC) according to the invention uses a new kind of image detecting system. Basically a biaxially tilting or swiveling micro-mirror scans the environment or an object in raster fashion and directs the light beam onto e.g. a single light detector element or an optoelectric sensor.

As shown in FIG. 1, the scanning camera SC according to the invention has a punctiform imaging sensor SE. The sensor SE consists of one element or one pixel. Particularly for a color camera, a plurality of pixels can be provided which are sensitive to the different colors. The imaging sensor SE can be implemented, for example, by a phototransistor, a CCD chip or a CMOS device.

The scanning camera SC additionally has a deflection unit implemented by a micro-mirror SP. According to the invention, the micro-mirror SP scans an object OB two-dimensionally. To this end, the micro-mirror SP is designed to tilt about two axes. These two tilting axes are preferably perpendicular to one another. This tilting movement is shown symbolically in FIG. 1 by the two double-headed arrows (not designated further). The solid angle scanned is directed or reflected onto the sensor SE. By this means, all the elements of an image to be detected are scanned on a time-division-multiplex basis and converted into image data by the sensor SE.

The deflection unit or micro-mirror SP can be implemented e.g. by so-called micromechanical elements (MEMS arrangements). An overview of such components can be viewed, for example, on the Internet via the URL http://mems.colorado.edu/cl.res.ppt/ppt/oe.review.

In the scanning camera SC according to the invention, the light-sensitive sensor SE is reduced to a single pixel point. All the elements of an image to be detected or of an object OB are recorded on a time-division multiplex basis. According to this principle, a collimating lens system can be dispensed with, which also eliminates focusing on the image distance.

FIG. 2 shows a possible implementation of the micro-mirror SP by a micromechanical element. The micromechanical element preferably consists of silicon from which a movable tongue Z is etched out. The tongue Z can be displaced perpendicularly to the plane of the drawing, e.g. with a frequency of approximately 30 to 40 kHz. This movement direction is symbolically represented by a double-headed arrow P1. The micro-mirror SP shown in FIG. 2 can be rotated further in the plane of the drawing, e.g. with a frequency of 50 Hz. This movement direction is symbolically represented by a double-headed arrow P2.

FIG. 3 illustrates another possible implementation of the micro-mirror SP. A mirror element SPM is displaceably connected to a silicon base on two sides in such a way that said element SPM can be displaced two-dimensionally. The oscillation frequencies are, for example, the same as in FIG. 2.

FIG. 4 shows a particularly preferred embodiment of the scanning camera SC according to the invention in which the micro-mirror SP and the imaging sensor SE are disposed in one plane. The micro-mirror SP and imaging sensor SE can be manufactured adjacent to one another e.g. as micromechanical elements on an integrated device, a chip CP.

To deflect a light beam LS reflected by the micro-mirror SP onto the sensor SE, there is provided a deflection mirror US.

The chip CP can be disposed in a recess in the housing GH and the opening can be covered by a glass plate GP. The light beam LS incident on the mirror SP through the glass plate GP is then directed via the deflection mirror US onto the sensor SE, the deflection mirror preferably being implemented by partially metal-coating the glass plate GP.

1. Scanning camera (SC)
having a two-dimensionally displaceable micro-mirror (SP) for scanning an object (OB) and for mapping it onto a punctiform optoelectric sensor (SE) designed to convert an image scanned on a time-division multiplex basis into electrical image data, the micro-mirror (SP) and the optoelectric sensor (SE) being disposed in one plane,
and a deflection mirror (US) being disposed in the optical path between micro-mirror (SP) and optoelectric sensor (SE).

2. Scanning camera (SC) according to claim 1,
wherein the micro-mirror (SP) and the optoelectric sensor (SE) are covered with a glass plate (GP), the deflection mirror (US) being implemented by at least partially metal-coating the glass plate (GP).

3. Scanning camera (SC) according to claim 1 or 2,
wherein the micro-mirror (SP) and the optoelectric sensor (SE) are disposed on a single chip (CP).
